(19) United States
(12) Patent Application Publication
(10) Pub. No.: US 2006/0046016 A1
(43) Pub. Date: Mar. 2, 2006

(54) CD, DVD disc protector

(76) Inventors: Johnny L. Brown, Temple Hills, MD (US); Charles A. Butler, Orlando, FL (US)

Correspondence Address: Steven L. Stephan, 958 Nicklaus Drive, Newport News, VA, 23602, US

(21) Appl. No.: 11/210,844

(22) Filed: Aug. 25, 2005

Related U.S. Application Data
(60) Provisional application No. 60/604,788, filed on Aug. 27, 2004.

(51) Int. Cl. B32B 3/02

(52) U.S. Cl. 428/66.6; 428/64.1

(57) ABSTRACT

This invention discloses a protective disc and structure to hold an optical data disc to the protective disc so that if the during use the combination of the data disc and protective disc are mishandled the protective disc does not permit the data to become scratched. Instead the protective disc might become scratched. The data disc is held to the protective disc in a releasable fashion so that it can be removed from the protective disc and attached to another if the first protective disc becomes scratched. The data disc can be held to the protective disc with a set of prongs which are attached to the protective disc and can extend into contact with the edges of the data disc, and/or also into contact with the top surface of the data disc at the outside edges. Another alternative for holding the data disc to the protective disc include a band which extends entirely around the circumference of the discs. These alternative holding devices can be either a continuous ring or two semicircular rings which are held together by hinges and/or by clasps.

This application is entitled to priority from provisional application 60/604788, filed Aug. 27, 2004 under 35 USC 120.

This invention relates to a protective disc which protects a CD or DVD from scratches.

### PRIOR ART

A problem with CD and DVD discs is they are easily scratched or marred to the point of not being readable by a CD or DVD player. When a scratched or marred CD or DVD disc is no longer readable by a CD or DVD player, the unreadable CD or DVD disc must be thrown away.

One solution to the above problem has been to place a transparent protective cover over the surface of a CD or DVD disc and hold it in place by means of annular rings of adhesive at the inside and outside of the disc as disclosed by U.S. Pat. No. 4,879,710. This system has the drawback that the protective disc is thin and relatively fragile. It must be protected itself by means of a release sheet before being applied to the CD or DVD. Then during application it is sometimes difficult to maintain the protective disc in a rigid condition so that as the thin protective sheet is applied to the CD or DVD, it can accidentally become wrinkled or folded, and in the process unusable if surfaces with adhesive come into contact with each other.

### ADVANTAGES OF THE INVENTION

This invention of this application overcomes the problems of the prior art by means of a transparent protective disc for a CD or DVD that is held in position on the Cd or DVD by means of a mechanical holding or latching means. The protective disc is usually about half the thickness of a CD or DVD disc, however any thickness would be permissible as long as the data on the CD or DVD disc can be read through the disc protective cover, and the cover remains sufficiently rigid to hold its shape.

By means of the protective disc being attached mechanically, if this mechanical means is designed properly, it is possible to provide a protective disc which can be removed form one Cd or DVD and placed on a different CD or DVD if desired, without destroying the protective disc, and it can be applied to a new or different CD or DVD. From this it is apparent that device of this invention provides a protective disc which is much more flexible in its use.

### DRAWINGS

Exemplary embodiments of the invention are shown in the drawings, in which:

FIGS. 1 and 1a show a first embodiment in which a protective disc of about the same circumference as a CD or a DVD has plurality of prongs which are spaced around the protective disc and hold it to a CD or DVD by being angled in to engage the outside edge of the CD or DVD;

FIGS. 2 and 2a show a modification in which one or more of the prongs extend straight from the protective disc, and at least one of the prongs is angled inwardly;

FIGS. 3 and 3a show another modification is which one or more of the prongs have a straight portion followed by a ledge which extends over the surface of the CD or DVD;

FIGS. 4 and 4a show another modification in which all of the prongs have a straight portion followed by a ledge which extends over the surface of the CD or DVD;

FIGS. 5-5b show an embodiment in which a rigid transparent protective disc is held to a CD or DVD by means of a first semicircular ring which is attached to the protective disc, and a second semicircular ring which is held to the first semicircular ring by box clasps. FIG. 5a shows a section taken through the vertical plane that includes line A-A of FIG. 5, and FIG. 5b shows a section through the vertical plane that includes line B-B of FIG. 5, FIGS. 5a and 5b are not drawn to scale;

FIG. 6 shows a modification in which one of the semicircular rings is attached to the protective disc and the other is attached at one end to an end of the first by a hings;

FIG. 7 shows a modification in which neither of the semicircular rings are attached to the protective disc;

FIG. 8 shows a modification in which neither of the semicircular rings is attached to the protective disc, however, the semicircular rings are attached to each other at one end of each by a hinge;

FIGS. 9 and 9a show an embodiment in which the ring is a single, flexible piece and the protective disc is separate from it, wherein FIG. 9 is schematic showing, and FIG. 9a shows a section through the vertical plane that includes line C-C of FIG. 9, and is enlarged for clarity; and

FIGS. 10 and 10a show an alternative in which the ring is made of heat shrink material. FIG. 10a shows a section through the vertical plane that includes line D-D of FIG. 10, and is enlarged for clarity.

FIGS. 11, 11a, and 11b show a box clasp locking mechanism. FIG. 11 shows a box clasp tongue with thumb piece. FIG. 11a shows a box clasp hole. FIG. 11b shows both box clasp tongue and hole mated. The box clap tongue has an outward pressure that presses inward as it mates with the box clasp hole. When the thumb of the box clap tongue mates with the box clasp hole, the box clasp tongue presses outward locking the two pieces together. To unlock the two pieces, press in on the thumb of the box clasp tongue and pull the two pieces apart.

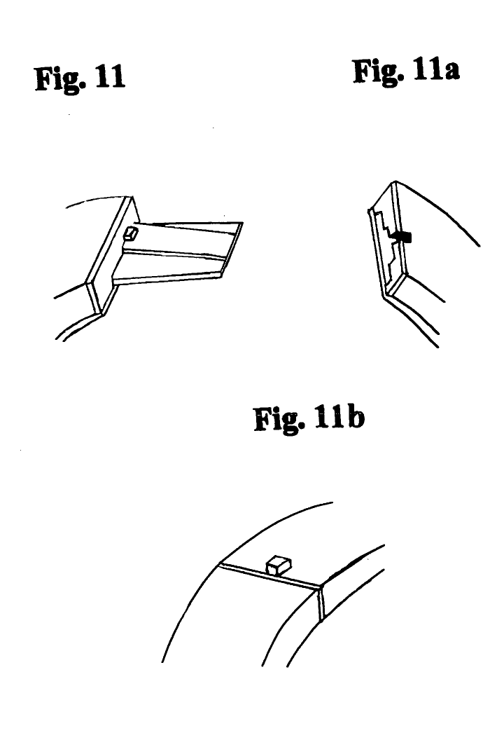

### DESCRIPTION OF THE EXEMPLARY EMBODIMENTS

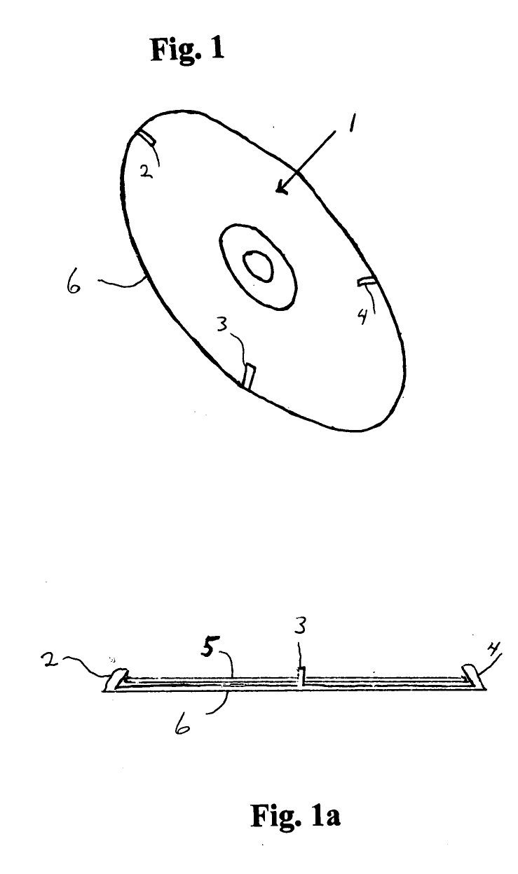

In FIGS. 1 and 1a, a rigid removable transparent protective plastic cover 1 is shown which is held in place on the readwrite side of the CD or DVD disc 5 by three prongs, 2, 3, 4 which are set approximately 120 degrees from each other. The disc protector cover is made of a rigid transparent plastic disc 6 that is the same, or approximately the same circumference as a CD or DVD. It is usually about half the thickness of a CD or DVD, however any thickness would be permissible as long as the data on the CD or DVD can be read through the disc of the protective cover. The three prongs 2, 3, 4 are about one and a half the height of a CD or DVD, and are set at an angle as shown in FIG. 1 a so that they slant inward toward the center of the label side of the CD or DVD disc. The three prongs are spaced apart from each other at approximately 120 degrees around the circumference of the disc, although the showing of their spacing about the disc is shown schematically in FIG. 1a. Each of the three prongs 2, 3, 4 that presses inward toward the center of the label side of the CD or DVD disc supplies an inward pressure against the CD or DVD disc and also against each of the two opposing prongs. It is this inward pressure that keeps the CD or DVD disc from separating from the disc of the protective cover.

To use the disc protector, a person lightly pulls back on one of the prongs and inserts a CD or DVD disc. The read/write side of the CD or DVD disc faces downward inside the prongs towards the disc of the protector. Once the CD or DVD lies flat against the disc of the protective cover, the prong which has been pulled back is released.

If the combination of a CD or DVD disc and its protector becomes scratched or marred to the point that it is no longer readable by a CD or DVD player, the actual CD or DVD disc is not damaged. Instead, it is the rigid, removable, transparent, protective, plastic cover that is damaged.

When the combination of a CD or DVD disc and its protector is scratched or marred to the point that it is no longer readable by a CD or DVD player, a person lightly pulls back on one of the prongs and the CD or DVD disc can be removed from the scratched protective cover. The scratched protective cover can then be thrown away, and a new protective cover installed on the CD or DVD.

As shown, three prongs are used, but more prongs could be used. They are preferably set at approximately 120 degrees from each other, or if more than three prongs are used, they are preferably spaced equally about the disc of the protector. However, different spacing of the prongs could be used, so long as they substantially oppose each other across the CD or DVD disc so that they can hold the disc protector to the CD or DVD. As another option, the disc protector can also have a continuous outer prong, extending around the entire outer circumference of the disc of the protector.

Also, the disc protector can be made of glass, or any other transparent material which is more or less rigid.

The disc protector can also be applied to any data storage medium that uses a laser or other optical head to read/write to a data storage medium such as a mini CD or a mini DVD.

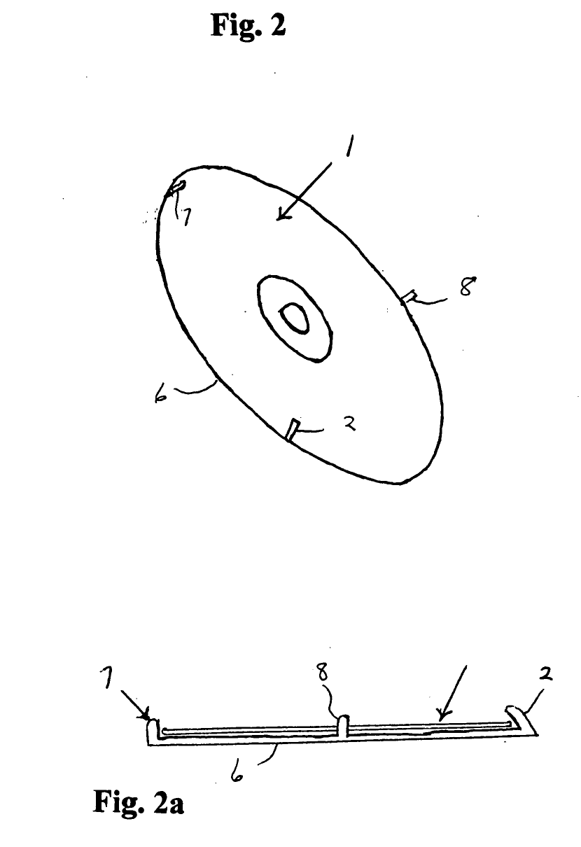

As shown in FIGS. 2 and 2a, the disc protector cover 1 is again made of a rigid removable transparent plastic disc 6 that is substantially the same circumference as a CD or DVD disc. It is about half the thickness of a CD or DVD disc. It has three prongs, 2, 7 and 8 on the outer circumference of the disc 6. The three prongs are about one and a half the height of a CD or DVD disc. Two of the three prongs, 7 and 8, are perpendicular to the surface of the disc protector. One of the three prongs, 2, is set at an angle so that it presses inward toward the center of the label side of the CD or DVD disc. The three prongs are set approximately 120 degrees from each other. The one prong that presses inward toward the center of the label side of the CD of DVD disc supplies an inward pressure against the CD or DVD disc and also against each of the two opposing prongs. It is this inward pressure that keeps the CD or DVD disc from separating from the disc protector.

To use the disc protector, a person lightly pulls back on the one prong 2 that presses inward and inserts a CD or DVD disc. The read/write side of the CD or DVD disc faces downward inside the prongs towards the disc protector. After the CD or DVD lies flat against the disc of the protector cover, the prong which has been pulled back is released.

To remove the CD or DVD protector, the prong 2, which presses inward, is lightly pulled back and the CD or DVD disc can be removed.

In this example again three prongs are shown, but as explained above, any number of prongs can be used. Also, the disc protector can be made of glass, or any other transparent material. The disc protector also applies to any data storage medium that uses a laser to readwrite to a data storage medium, such as a mini CD or a mini DVD.

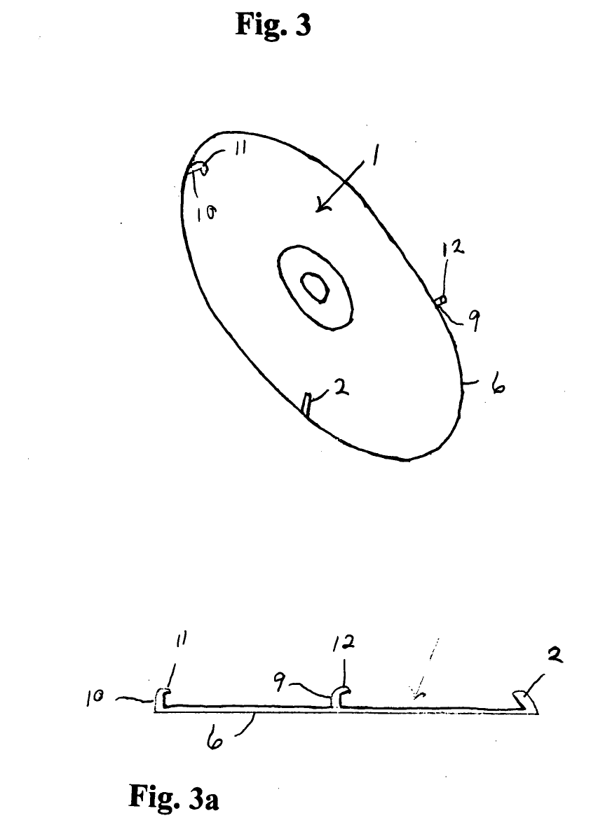

The invention as shown in FIGS. 3 and 3a is again made of a rigid removable transparent plastic disc that is substantially the same circumference as a CD or DVD disc. It is about half the thickness of a CD or DVD disc. It has three prongs, 2, 9 and 10 on the outer circumference of the disc of the protector. The three prongs are each about one and a half the height of a CD or DVD disc. Two of the three prongs, 9 and 10, extend perpendicular to the surface of the disc of the protector, and each of these two have a ledge, 11, 12, at their top that goes over the label side of a CD or DVD disc. The ledges are shown somewhat schematically in FIGS. 3 and 3a. The ledges point toward the center of the CD or DVD disk. The two ledges 11, 12, that extend over the top of the CD or DVD disc extend over the top only far enough to secure the CD or DVD disc into place. One of the three prongs, 2, is set at an angle so that it presses inward toward the center of the label side of the CD or DVD disc. The three prongs are set approximately 120 degrees from each other. The prong 2 that presses inward toward the center of the label side of the CD or DVD disc supplies an inward pressure against the CD or DVD disc, and also against each of the two opposing prongs. It is this inward pressure that keeps the CD or DVD disc from separating from the disc protector. Also, the two prongs 9, 10 that have a ledge 11, 12, that goes over the top of a CD or DVD disc help to lock the CD or DVD disk in place. The inward pressure and ledges work together to secure the CD or DVD disk to the protector.

The disc protector as shown in FIGS. 3 and 3a is installed on and removed from the disc in the same fashion as the protector which is shown in FIGS. 1 and 2.

Again in this example, three prongs are shown, but any number of prongs could be used. Also, as before, the disc protector can be made of glass or any other material which is transparent and otherwise suitable. The disc protector also applies to any data storage medium that uses a laser to readwrite to a data storage medium such as a mini CD or a mini DVD.

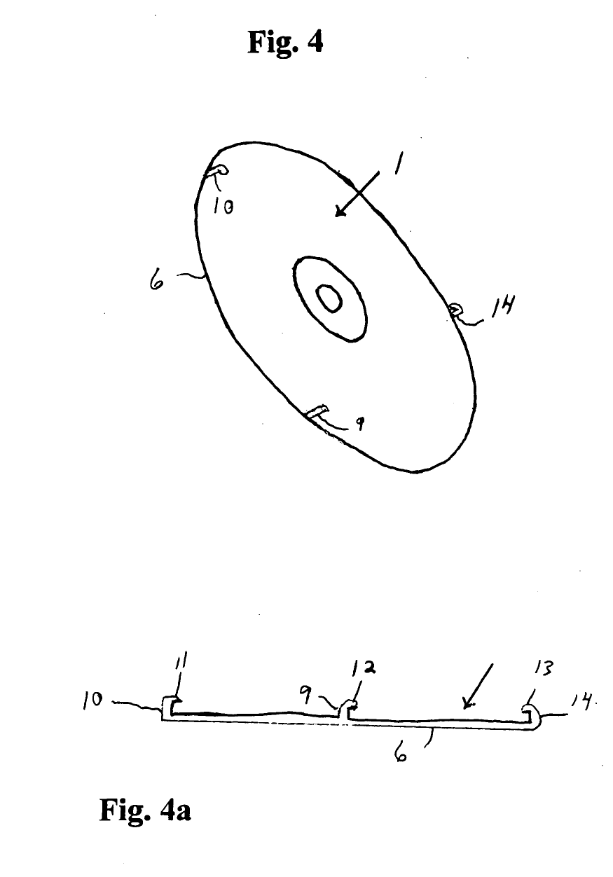

As shown in FIGS. 4 and 4a, the disc protector cover can be made of a rigid removable transparent plastic disc 6 that is substantially the same circumference as a CD or DVD disc. It is about half the thickness of a CD or DVD disc. It has three prongs, 9, 10 and 14 on the outer circumference of the disc of the protector. The three prongs are about one and a half the height of a CD or DVD disc. The three prongs are perpendicular to the surface of the disc of the protector and each has a ledge such as 11, 12 and 13 at their very top that goes over the label side of a CD or DVD disc. The ledges 11, 12 and 13 point toward the center of the CD or DVD disk. The three ledges that extend over the top of the CD or DVD disc extend over the top only enough to secure the CD or DVD disc. The three prongs are set approximately 120 degrees from each other. The ledges on the three prongs each go over the top of a CD or DVD disc locking the CD or DVD disk in place. Again in this example three prongs are shown, but more could be used. And even a continuous outer prong around the entire outer circumference of the disc of the protector could be used. Also, the disc protector can be made of glass or any other relatively rigid transparent material. The disc protector also applies to any data storage medium that uses a laser to readwrite to a data storage medium such as a mini CD or a mini DVD.

To use this version of the disc protector, again the prongs are positioned, and are sufficiently flexible so that a person can lightly pull back on one of the three prongs and insert a CD or DVD disc onto the disc 6 of the protective cover. The read/write side of the CD or DVD disc faces downward inside the prongs towards the disc protector. After the CD or DVD lies flat against the disc of the protector cover, the prong which was pulled back is released.

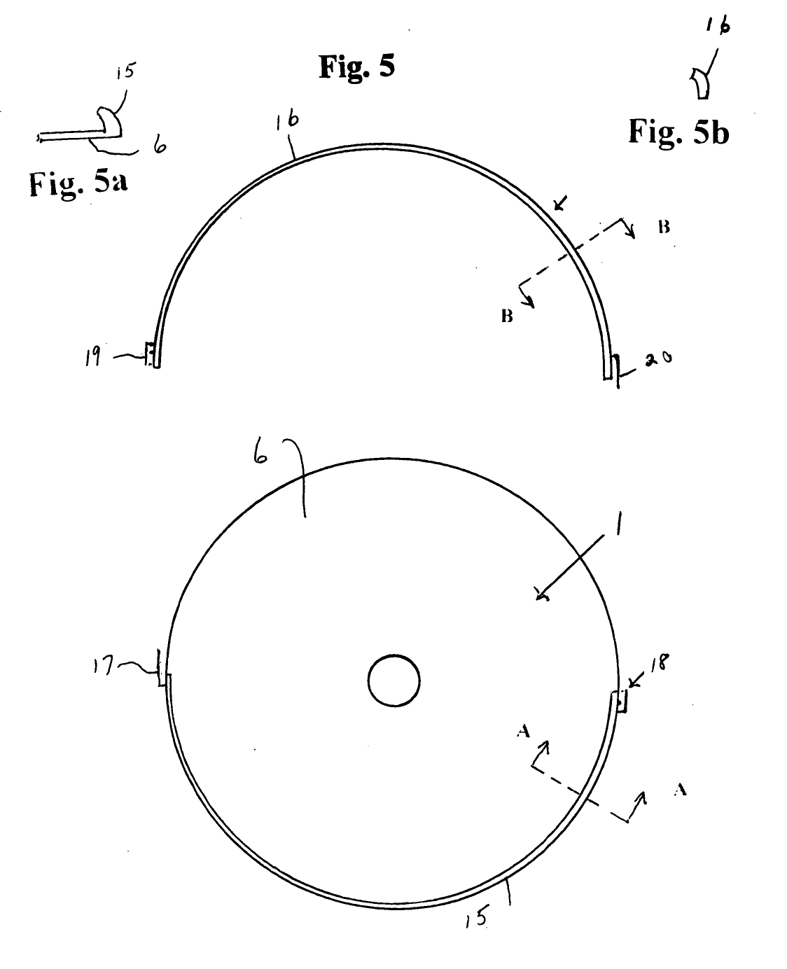

The embodiment as shown in FIGS. 5-5b has a semicircular ring 15 attached to the disc 6 of the protector cover and another semicircular ring attaches to the first semicircular ring by means of a pair of box clasps. The disc of the protective cover is made of a rigid transparent plastic and is substantially the same circumference as a CD or DVD disc. It is about half the thickness of a CD or DVD disc. The semicircular ring 15 which is attached to the protective disc is about one and a half the height of a CD or DVD disc and is concave. At both ends of this semicircular ring is a box clasp tongue 17, 18, shown schematically in FIG. 5, that will mate with a box clasp hole 19, 20, in a second semicircular ring 16.

The second semicircular ring 16 is concave as shown in FIG. 5b so that the concavity can accept both the protective disc and the CD or DVD. This semicircular ring goes over the outer circumference of both the CD or DVD disc and disc protector. It is also about one and a half the height of a CD or DVD disc. At both ends of this semicircular ring is a box clasp hole 19, 20 that will mate with the box clasp tongues 17, 18 on the semicircular ring 15 which is attached to the disc of the protector. Of course, the tongues and holes could be mounted on the opposite semicircular rings if desired, or they could be mixed so that each semicircular ring has one of each.

The semicircular ring 15 on the disc of the protector, and the separate semicircular ring 16 are only wide or thick enough to allow for a box clasp locking mechanism to be mounted thereon.

To use the disc protector, a CD or DVD disc is placed onto the disc of the protector. The CD or DVD disc fits against the disc of the protector 1 and its semicircular ring 15, and concaved semicircular ring 16 is then attached to the disc protector. The readwrite side of the CD or DVD disc faces downwardly against the disc protector. The separate semicircular ring goes 16 over both the CD or DVD disc and disc of the protector. The box clasp tongues 17, 18 will lock into place with the box clasp holes 19, 20 on the separate semicircular ring. The box clasp locking mechanism, along with the concave semicircular ring will prevent the CD or DVD disc and the disc protector from separating.

To remove the disc protector, a person presses against both box clasp tongues and removes the separate semicircular ring 16. The CD or DVD can then be taken out of the disc protector 1 and placed on a new protector so that the CD or DVD disc always remains protected and does not become scratched.

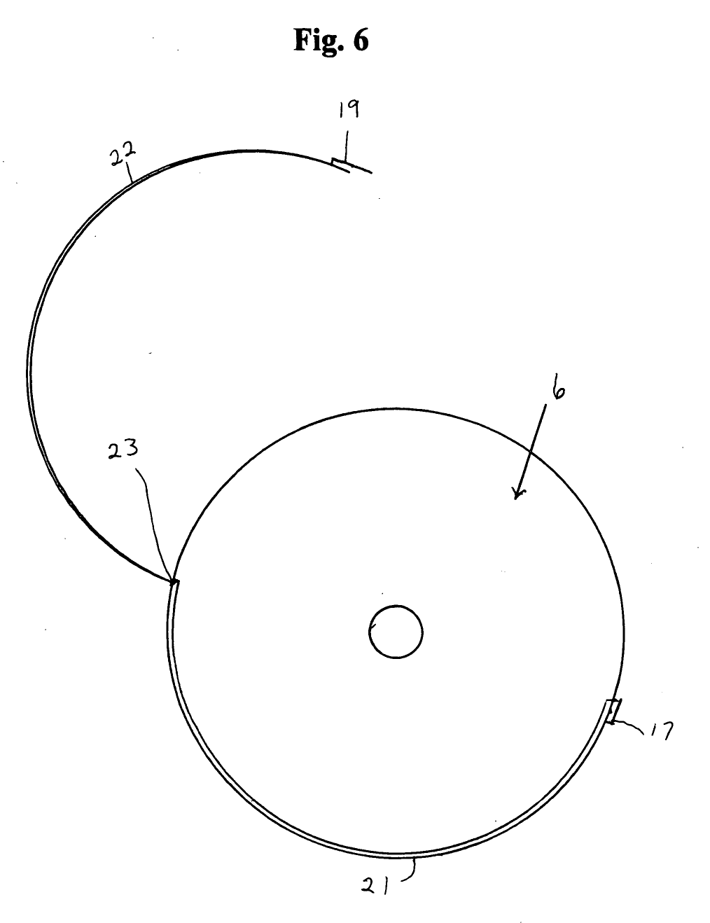

The embodiment of FIG. 6 has a disc protector that consists of two parts: a rigid removable transparent plastic disc 6 that is substantially the same circumference as a CD or DVD disc and is about half the thickness of a CD or DVD disc. It has a plastic retaining ring. The ring is the same circumference as a CD or DVD disc and is about one and a half the height of a CD or DVD disc and is concave. The ring consists of two semi-circles 21 and 22 which are attached to each other at one end of each by a hinge 23. At the other end of the two semicircular rings is a box clasp 17, 19. One of the semicircular rings has a tongue and the other has a box clasp hole.

To use the disc protector, a CD or DVD disc is placed onto the disc protector so that it contacts the concave side of the first semicircular ring 21, then the other semicircular ring 22 is swung over the other half of the CD or DVD disc and disc protector. The box clasp tongue on one of the semicircular rings can then lock into place with the box clasp hole of the other semicircular ring.

The box clasp locking mechanism, along with the concave semicircular rings, will then prevent the CD or DVD disc and disc protector from separating.

To remove the disc protector, the box clasp tongue is released from the hole, and the second semicircular ring 22 can be swung away.

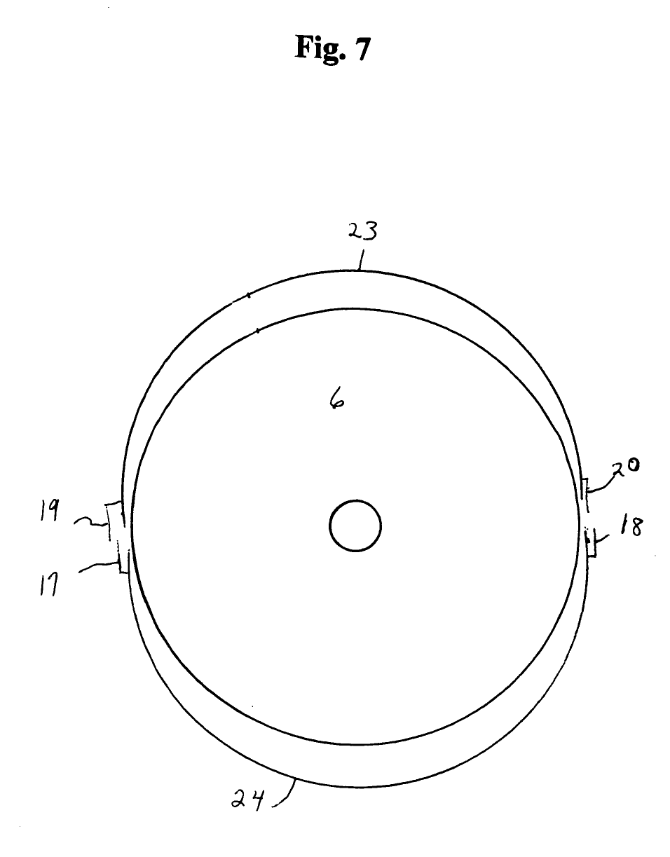

In FIG. 7 the disc protector is shown as consisting of three parts: a rigid removable transparent plastic disc 6 that is substantially the same circumference as a CD or DVD disc and is about half the thickness of a CD or DVD disc, an outer semicircular ring 23 with a box clasp hole 19, 20at both ends, and another outer semicircular ring 24 with a box clasp tongue 17, 18 at both ends of this outer semicircular ring. The two semicircular rings are about one and a half the height of a CD or DVD disc and are concave so they will hold the disc and disc protector together and not fall off from the disc and disc protector.

To use this disc protector, the readwrite side of a CD or DVD disc is placed onto the disc 6 of the protector and one of the semicircular rings is slipped around the outer circumference of both the CD or DVD disc and disc protector. The other semicircular ring around the outer circumference of the other half of the CD or DVD disc and disc protector. The box-clasp tongues on one ring can then lock into place with the box clasp holes of the other ring. The box clasp locking mechanism along with the concave semicircular rings will prevent the CD or DVD disc and disc protector from separating.

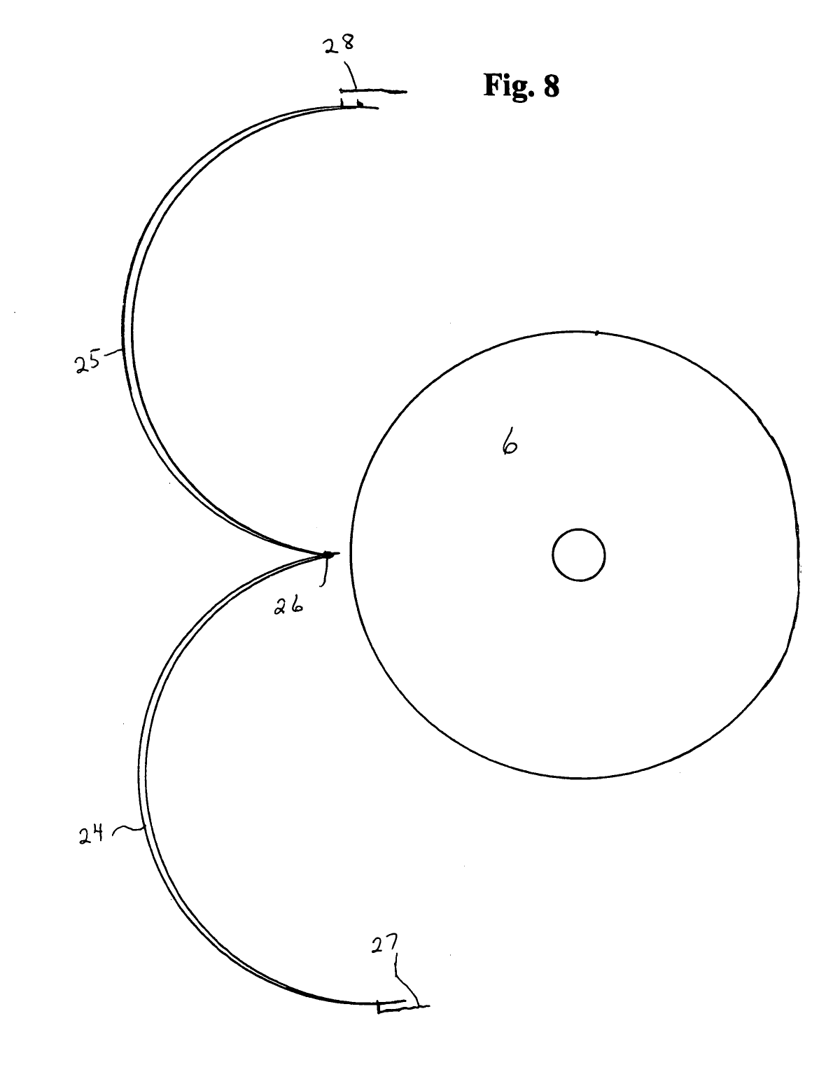

The structure shown in FIG. 8 has a disc protector cover which is made of a rigid removable transparent plastic disc 6 that is substantially the same circumference as a CD or DVD disc. It is about half the thickness of a CD or DVD disc. The disc protector has two semicircular rings 24, 25. The semicircular rings are about one and a half times the height of a CD or DVD disc and are concave in their cross section so that they will engage and hold the protective disc and CD or DVD together. At one end of each semicircular ring is hinge 26 which attaches it to the other semicircular ring. At the other end of one of the semicircular rings is a box clasp tongue 27 that will be accepted into a box clasp 28 hole in the other end of the other semicircular ring. The box clasp locking mechanism along with the concave semicircular rings will lock both the CD or DVD disc and disc protector into place.

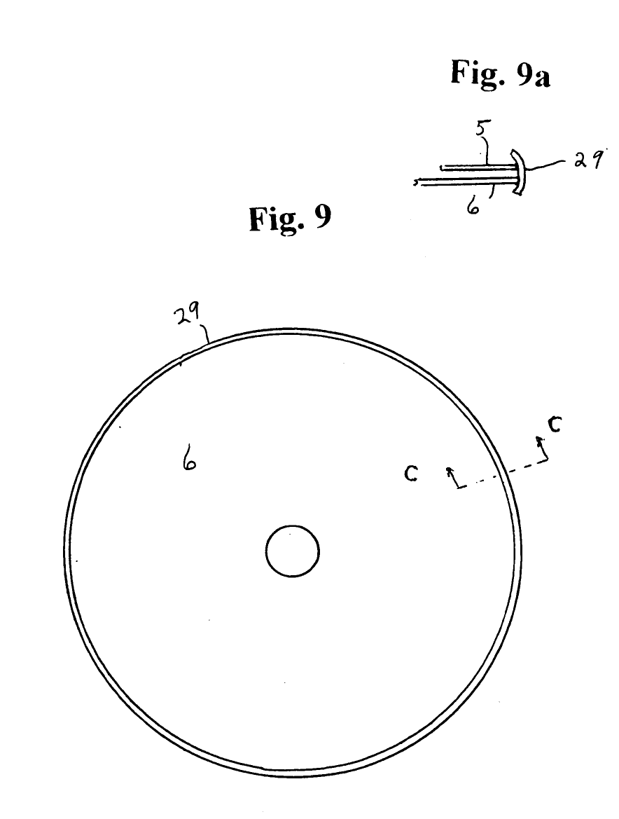

This embodiment of the disc protector shown in FIG. 9 consists of two parts: a rigid removable transparent plastic disc 6 that is substantially the same circumference as a CD or DVD disc and is about half the thickness of a CD or DVD disc, and a flexible plastic retaining ring 29. The ring 29 is the same circumference as a CD or DVD disc and is about one and a half the height of a CD or DVD disc. The ring 29 is concave in its cross section as shown in FIG. 9a so that it will hold and retain the protective disc 6 to the CD or DVD 5.

To use this disc protector, the readwrite side of a CD or DVD disc 5 is placed onto the disc 6. Then a part of the flexible plastic retaining ring 29 is slipped over and around a portion of the edges of both the CD or DVD 5 disc and disc 6 of the protector. The flexible plastic retaining ring 29 is then slipped over and around the rest of the CD or DVD disc and disc protector. By lightly pulling back on the flexible plastic retaining ring and continuing to slip the ring over and around the CD or DVD disc and disc protector.

The inward contracting force of the flexible plastic retaining ring keeps the CD or DVD disc 5 and disc 6 of the protector from separating. This disc protector can be removed by pulling back on a portion of the flexible plastic retaining ring while slipping the CD or DVD disc and disc protector out from the ring.

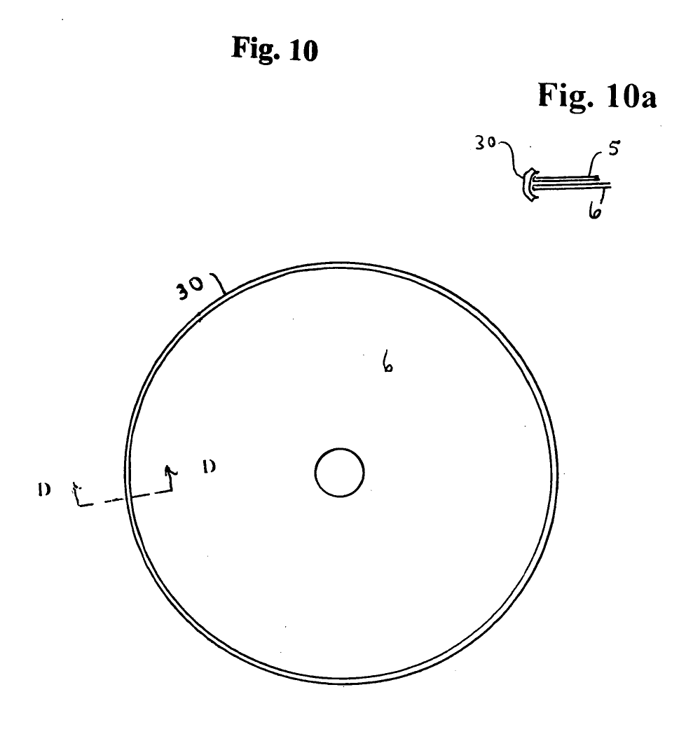

The embodiment of the disc protector shown in FIGS. 10 and 10a consists of two parts: a rigid removable transparent plastic disc 6 that is substantially the same circumference as a CD or DVD disc 5 and is about half the thickness of a CD or DVD disc, and a ring 30 of heat-shrinkable material. The heat-shrinkable material ring 30 is the same circumference as a CD or DVD disc and is about one and a half the height of a CD or DVD disc and is concave in its cross section. The disc protector can be placed on a CD or DVD by placing the readwrite side of a CD or DVD disc onto the disc protector and slipping a part of the heat-shrinkable material ring over and around a portion of both the CD or DVD disc and disc protector. As the heat-shrinkable material is slipped over and around the CD or DVD disc and disc protector, the heat-shrinkable material is lightly pulled and continued to be slipped over and around the rest of the CD or DVD disc and disc protector. Then gentile heat is applied to the heat-shrinkable material of the ring until its material is contracted.

The contraction of the heat-shrinkable material of the ring holds the CD or DVD disc and disc protector together. This protector can be removed by pulling off the heat-shrinkable material. This protector can then be replaced with a new one.

As an alternative, the heat shrinkable material could also be manufactured integrally with the plastic disc protector.

while the material of the rings has not been specified, they can be made of metal, plastic, or any other appropriate material.

We claim:

1. A protector for use with an optical data disc, which protector protects the data disc from scratches or other damage which might prevent an optical data disc reader from reading the data on the data disc, the protector including a transparent protector disc which is substantially the same diameter as the data disc, and means for holding the data disc to the protector disc, the means for holding including at least a portion which engages the edge of the data disc and thereby holds the data disc in position with its data surface adjacent to a surface of the protective disc and thus protected thereby, so that the data on the data disc can be read through the transparent protector disc, the means for holding the data disc being releasable so that the data disc can be removed form the protective disc.

2. A protector for use with an optical data disc as recited in claim 1, wherein the means for holding includes three or more prongs that are attached to the edge of the protector disc and engage the edge of the data disc when it is positioned properly on the protector disc, at least one of the prongs being slanted inwardly so that as it engages the edge of the data disc it holds the data disc engaged with the other prongs, so that the three or more prongs hold the data disc adjacent to the protector disc.

3. A protector for use with an optical data disc as recited in claim 2, wherein the other prongs are also slanted inwardly.

4. A protector for use with an optical data disc as recited in claim 2, wherein the other prongs are perpendicular to the surface of the protector disc.

5. A protector for use with an optical data disc as recited in claim 4, wherein the other prongs each have an end which is attached to the protector disc, a top which extends away from the protector disc, and a ledge which extends inwardly from the top of each prong.

6. A protector for use with an optical data disc as recited in claim 1, wherein the means for holding includes three or more prongs that are attached to the edge of the protector disc and engage the edge of the data disc when it is positioned properly on the protector disc, wherein the prongs are perpendicular to the surface of the protector disc.

7. A protector for use with an optical data disc as recited in claim 6, wherein the prongs each have an end which is attached to the protector disc, a top which extends away from the protector disc, and a ledge which extends inwardly from the top of each prong.

8. A protector for use with an optical data disc as recited in claim 1, wherein the means for holding includes a ring which surrounds the circumference of the protector disc and the data disc.

9. A protector for use with an optical data disc as recited in claim 8, wherein the ring is a pair of semicircular ring sections.

10. A protector for use with an optical data disc as recited in claim 9, wherein one of the semicircular ring sections is attached to the protector disc.

11. A protector for use with an optical data disc as recited in claim 10, wherein the semicircular ring sections are attached to each other at one end by a hinge.

12. A protector for use with an optical data disc as recited in claim 10, wherein the semicircular ring sections are attached to each other at both ends by a box clasp mechanism.

13. A protector for use with an optical data disc as recited in claim 8, wherein the ring includes a concave portion that engages both the data disc and the protector disc.

14. A protector for use with an optical data disc as recited in claim 13, wherein the ring is a single piece.

15. A protector for use with an optical data disc as recited in claim 14, wherein the ring is flexible and can be installed around the data disc and the protector disc by slightly expanding it.

16. A protector for use with an optical data disc as recited in claim 14, wherein the ring is a heat shrink ring which can be shrunk after being placed in position around the circumference of the data disc and the protector disc.
